(19) United States
(12) Patent Application Publication
(10) Pub. No.: US 2020/0290296 A1
(43) Pub. Date: Sep. 17, 2020

(54) PREPARATION OF A COMPOSITE MATERIAL COMPRISING DIFFERENT FUNCTIONALITY AREAS

(71) Applicant: Saint-Gobain Performance Plastics France, Charny Orée de Puisaye (FR)

(72) Inventors: Nicolas DUMONT, Gradignan (FR); Gaëtan MAO, Pessac (FR)

(21) Appl. No.: 16/815,119

(22) Filed: Mar. 11, 2020

(30) Foreign Application Priority Data
Mar. 11, 2019 (FR) 1902453

(51) Int. Cl. B29C 70/24; B29C 70/02

(52) U.S. Cl. CPC B29C 70/24; B29C 70/02

(57) ABSTRACT

The present disclosure relates to a process for manufacturing a product made of composite materials comprising areas with different functionalities from a knitted preform. The inventors have discovered that it is possible to knit a dry preform comprising areas of different composition and then to transform same by melting into a solid composite material comprising areas with different functionalities. By different functionality, it is possible to provide areas of different rigidity, areas of different abrasion resistance, and areas of different electrical conductivity or thermal conductivity, areas of different transparency.

### CROSS-REFERENCE TO RELATED APPLICATION(S)

This Application claims priority under 35 U.S.C. § 119(a)-(d) to French Patent Application No. 1902453, entitled “PREPARATION OF A COMPOSITE MATERIAL COMPRISING DIFFERENT FUNCTIONALITY AREAS,” by Nicolas DUMONT et al., filed Mar. 11, 2019, which is assigned to the current assignee hereof and incorporated herein by reference in its entirety.

### FIELD OF THE DISCLOSURE

The present disclosure relates to a method of preparation of a composite material that includes different functional areas.

### BRIEF DESCRIPTION OF THE DRAWINGS

Embodiments are illustrated by way of example and are not limited to the accompanying figures.

FIG. 1 includes an illustration of a product that includes different flexibility areas.

FIG. 2 includes an illustration of a product that includes areas of different abrasion resistance.

FIG. 3 includes an illustration of a product that includes areas of different thermal conductivity.

FIG. 4 includes an illustration of a preform that includes areas of different transparency.

FIG. 5 includes an illustration of a product obtained from the preform of FIG. 4 that includes areas of different transparency.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive—or and not to an exclusive—or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

The invention relates to the field of products made of composite material(s). Composite materials is understood to mean a product comprising a matrix constituted from a polymeric material, in particular a thermoplastic or thermosetting material, this matrix being reinforced by a material having a melting point higher than the melting point of the polymeric material. FRP usually refers to “fiber reinforced plastic”.

Composite materials have been well known for many years. They have good mechanical resistance with respect to the weight of the material. They also have very good resistance to corrosion. They have properties superior to those of the components taken separately.

They allow in particular, in the automotive or aeronautic fields, the lightening of pieces traditionally made of steel. They also have a good resistance to fatigue.

Reinforcements can be obtained in different ways: by adding mineral fibers dispersed in the matrix, by using a steel frame or synthetic material, by using a fabric of reinforcing fibers, by the use of nonwovens or mats, or other products obtained by textile processes.

The fabric reinforcements have a flat structure and are composed of weft yarn and warp yarn arranged to be perpendicular. The manufacture thereof requires the use of a separate spool for each warp yarn.

More recently, the use of knitted reinforcements has been apparent. Knitted reinforcements is understood to mean a product generally obtained from continuous yarn where the yarn forms an interlaced mesh arrange in successive rows. The production of a traditional knit requires only one spool of yarn for the yarn mesh.

The yarn can be of the monofilament or multifilament type. The multifilament can be a roving (that is to say a set of parallel continuous filaments assembled without twisting), a yarn of fibers (that is to say a set of short discontinuous fibers assembled by twisting). A yarn can also be an assembly of several yarns or filaments of different materials. This assembly can be used for twisting, braiding, etc. It is therefore possible to produce a yarn comprising polymeric material and reinforcing material. For example, it is possible to assemble a reinforcement yarn of the aramid, carbon, glass type, etc., and a thermoplastic yarn (polypropylene, polycarbonate, polyetherimide (PEI), etc.). This type of yarn is then called mixed yarn.

The knitting of this type of mixed yarn makes it possible to obtain a dry preform, containing both the reinforcement and the matrix.

Compared to woven reinforcements, knitted reinforcements have many advantages.

Woven reinforcements pre-impregnated with polymeric material, for example gelled, which are generally called a “prepreg”, must be handled gently. They are sticky when the protective film is removed. They can only be kept for a limited period at room temperature.

The draping of woven reinforcements on a mold is a long and delicate operation. It requires the use of several layers of “prepreg”, which must be cut and arranged judiciously according to the shape of the mold to ensure a sufficient thickness while avoiding too much overlap.

Cutting prepreg fabrics involves product scraps which can represent 30% of the material. In addition, making a fabric requires hundreds of spools.

The production of a traditional knit requires only one spool of yarn for the yarn mesh. Different knitting techniques make it possible to obtain knits forming a single piece, in 3D, without sewing. Known knitting techniques allow circular knitting or straight knitting to be carried out.

A distinction is made between weft knitting methods and warp knitting methods.

In weft knitting, (also called picked stitch), the yarn preferably follows the direction of the rows (weft direction by analogy to a fabric). Each loop of the same row is knitted one after the other. Each row is knitted one after the other. A single yarn can be used to make the entire knitting. Each needle is controlled individually; it is possible to achieve a complex 3D shape during knitting.

In warp knitting (also known as throw stitch), the yarn preferably follows the direction of the columns (warp direction by analogy to a fabric). All the loops in the same row are knitted at the same time. Each row is knitted one after the other. One yarn is needed per mesh column. The needles are linked in different groups. It is possible to individually control the groups but not the needles constituting them. The knits produced are flat. Thickness is nevertheless possible but no complex 3D shapes).

The holder's patent application FR 3065181 teaches a process for producing a dry preform for the manufacture of a product made of composite materials. This document describes a preform produced by weft knitting of at least one mesh yarn and at least one unidirectional reinforcing yarn. This preform no longer requires the injection of a resin because it is formed from knitting of a mixture of yarn or filaments of reinforcement material and of yarn or filaments of thermoplastic material, this latter being intended to melt during shaping. The knitted yarn actually consists of a mixture of filaments made of thermoplastic material and filaments made of reinforcing material.

Document US 2012/0168012 describes composite tubes produced by liquid impregnation. They comprise a circular knitted structure serving as a support to which a polymer matrix is applied by impregnation in a mold. Successive additional layers are also added before consolidating the set.

There is a need to produce products from composite material that comprise areas with different functionalities. By different functionalities, we mean for example: an area allowing drilling/cutting, in a piece of material resistant to drilling/cutting; a flexible area in a rigid piece; a thermally conductive area in a thermally insulating piece.

With the traditional methods of manufacturing composite materials, pieces from different materials should be made separately and then assembled.

The assembly is a delicate step. The assembled composite has a more fragile area at the assembly points. The assembly also causes a discontinuity of certain properties, in particular electrical properties, or requires carrying out a specific treatment. The assembly can also generate a discontinuity in the surface which can create turbulence (cf. aeronautical profile). The assembly also causes overweight due to the introduction of other materials.

The object of the present invention is to provide composite materials comprising different interpenetrating functionalities, without the need to separately assemble pieces produced beforehand.

According to particular embodiments, it has been discovered that it is possible to knit a dry preform that may include areas of different composition and then transform the same by melting it into a solid composite material that may include areas with different functionalities. The functions can be generally only available after merging.

According to certain embodiments, when knitting, it is possible to use yarns of different materials in certain areas. These different materials can provide a particular functionality in a particular area of the final composite product.

According to still other embodiments, the present invention can relate to a method for manufacturing a product that can be made of composite material that may include a matrix of polymeric material reinforced by fibers, the polymeric material having a melting point lower than the melting point of the material that constitutes the reinforcing fibers. The product can include at least two areas with different functionalities. According to certain embodiments, in at least one area, the polymeric material can represent at least 50% by weight of the final product.

According to particular embodiments, the method according to the invention may include at least the following steps: production of knitting in three dimensions and in a continuous piece, by the weft knitting method, the knitting constituting a dry preform corresponding to the shape of the product to be obtained and may include at least two areas of different composition; shaping by heating under pressure to reach at least the melting point temperature of the polymeric material without reaching the melting point temperature of the reinforcing material; and cooling of the product thus obtained.

According to certain embodiments, three-dimensional knitting can potentially be non-axisymmetric and/or with closed and/or completely open facies. The knitting can be done by the straight or circular knitting method.

According to yet other embodiments, advantageously, knitting is carried out by straight knitting which makes it possible to obtain complex 3D shapes, which would not be the case with circular knitting.

According to particular embodiments, the preform can have two different areas or a plurality of different areas.

According to yet other embodiments, polymeric material can be understood to mean thermosetting materials, such as, for example, epoxy resins, polyester resins, etc. According to yet other embodiments, polymeric material may be understood to mean thermoplastic materials, such as, polycarbonate, polypropylene, polyamide, polyurethane, PMMA, low-density polyethylene terephthalate, polyetherimide, polyetheretherketone (PEEK), polyetherketoneketone (PEKK), etc.

According to still other embodiments, reinforcing materials can include synthetic materials, such as, aramids (para-; meta-), polyamide, polyethylene terephthalate, polyester; natural materials, such as linen, hemp; inorganic materials such as glass, quartz, carbon, basalt, etc.

According to particular embodiments, the polymeric material can represent, in at least one area of the final product, from 55% to 85% by weight of the finished product, preferably from 60% to 80% by weight of the finished product.

According to one embodiment, the preform is produced by knitting a mixed yarn comprising polymeric material and reinforcing material.

According to another embodiment, the preform is produced by knitting a reinforcing yarn; the polymeric material being introduced in a liquid process into a mold.

According to still other embodiments, depending on the desired application, the areas of composition different from the preform can be produced by varying the nature, density, and or composition of the reinforcing fibers.

According to still other embodiments, these different areas can generate different properties in the finished product, which can be different flexibility, different thermal conductivity, different electrical conductivity or different abrasion resistance.

According to particular embodiments, the preform may include at least two areas that may include different reinforcing materials.

According to still other embodiments, the method according to the invention is particularly advantageous because the finished products have no connection (thus continuity of the aerodynamic profile) and does not require any assembly of different pieces. The materials being interpenetrated, their mechanical resistance is increased and the potential failure of the connecting element does not occur

According to particular embodiments,

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method for manufacturing a product made of composite material, wherein the product comprising a matrix of a polymeric material reinforced with fibers, the polymeric material having a melting point lower than the melting point of a material constituting the reinforcing fibers, wherein the product further comprises at least two areas with different functionalities, wherein at least one area comprises at least 50% polymeric material by weight of the final product, wherein the process comprise the following steps:
making a knit in three dimensions and in a continuous piece by weft knitting, the knit constituting a dry preform corresponding to the shape of the product to be obtained, wherein the dry preform comprises at least two areas having different compositions,
shaping by heating under pressure to reach at least the melting point temperature of the polymeric material without reaching the temperature of the melting point of the reinforcing material, and
cooling of the product thus obtained.

Embodiment 2. The method according to embodiment 1, wherein production of the knitting in three dimensions is carried out by knitting a straight weft.

Embodiment 3. The method according to any one of embodiments 1 and 2, wherein at least one area of the final product comprises from 55% to 85% polymeric material by weight of the final product.

Embodiment 4. The method according to any one of the preceding embodiments, wherein the preform is produced by knitting a mixed yarn comprising polymeric material and reinforcing material.

Embodiment 5. The method according to any one of embodiments 1 and 3, wherein the preform is produced by knitting a reinforcing yarn; the polymeric material being introduced in a liquid way into a mold.

Embodiment 6. The method according to any one of the preceding embodiments, wherein the preform comprises at least two areas comprising different reinforcing materials.

Embodiment 7. The method according to any one of the preceding embodiments, wherein the two areas of the preform are capable of forming areas having different flexibility in the final composite product.

Embodiment 8. The method according to any one of embodiments 1, 2, 3, 4, 5, and 6, wherein the two areas of the preform are capable of forming areas having different thermal conductivity in the final composite product.

Embodiment 9. The method according to any one of embodiments 1, 2, 3, 4, 5, and 6, wherein the two areas of the preform are capable of forming areas having different abrasion resistance in the final composite product.

Embodiment 10. The method according to any one of embodiments 1, 2, 3, 4, and 5, wherein the two areas of the preform are capable of forming areas having different transparency.

Embodiment 11. The method according to any one of the preceding embodiments, wherein the polymeric material is chosen from polycarbonate, polypropylene, polyamide, polyurethane, PMMA, low-density polyethylene terephthalate, polyether imide, polyetheretherketone (PEEK), polyetherketoneketone (PEKK).

Embodiment 12. The method according to any one of the preceding embodiments, wherein the reinforcing material is chosen from para-aramids, meta-aramids, polypropylene, polyamide, polyethylene terephthalate, polyester, linen, hemp, glass, quartz, carbon, basalt.

Embodiment 13. A use of a dry preform obtained by knitting a rectilinear weft in 3D for the manufacture of a product of composite material comprising areas with different functionalities.

Embodiment 14. The use according to embodiment 13, wherein the dry preform is obtained by knitting a mixed yarn comprising polymeric material and reinforcing material.

Embodiment 15. The use according to embodiment 13, wherein the dry preform is obtained by knitting a yarn of reinforcement material; of the polymeric material being added during an injection step in a mold.

Embodiment 16. A method for manufacturing a product made of composite material, wherein the product comprising a matrix of a polymeric material reinforced with fibers, the polymeric material having a melting point lower than the melting point of a material constituting the reinforcing fibers, wherein the product further comprises at least two areas with different functionalities, wherein at least one area comprises at least 50% polymeric material by weight of the final product, wherein the process comprise the following steps:
making a knit in three dimensions and in a continuous piece by weft knitting, the knit constituting a dry preform corresponding to the shape of the product to be obtained, wherein the dry preform comprises at least two areas having different compositions,
shaping by heating under pressure to reach at least the melting point temperature of the polymeric material without reaching the temperature of the melting point of the reinforcing material, and
cooling of the product thus obtained.

Embodiment 17. The method according to embodiment 16, wherein production of the knitting in three dimensions is carried out by knitting a straight weft.

Embodiment 18. The method according to embodiment 16, wherein at least one area of the final product comprises from 55% to 85% polymeric material by weight of the final product.

Embodiment 19. The method according to embodiment 16, wherein the preform is produced by knitting a mixed yarn comprising polymeric material and reinforcing material.

Embodiment 20. The method according to embodiment 16, wherein the preform is produced by knitting a reinforcing yarn; the polymeric material being introduced in a liquid way into a mold.

Embodiment 21. The method according to embodiment 16, wherein the preform comprises at least two areas comprising different reinforcing materials.

Embodiment 22. The method according to embodiment 16, wherein the two areas of the preform are capable of forming areas having different flexibility in the final composite product.

Embodiment 23. The method according to embodiment 16, wherein the two areas of the preform are capable of forming areas having different thermal conductivity in the final composite product.

Embodiment 24. The method according to embodiment 16, wherein the two areas of the preform are capable of forming areas having different abrasion resistance in the final composite product.

Embodiment 25. The method according to embodiment 16, wherein the two areas of the preform are capable of forming areas having different transparency.

Embodiment 26. The method according to embodiment 16, wherein the polymeric material is chosen from polycarbonate, polypropylene, polyamide, polyurethane, PMMA, low-density polyethylene terephthalate, polyether imide, polyetheretherketone (PEEK), polyetherketoneketone (PEKK).

Embodiment 27. The method according to embodiment 16, wherein the reinforcing material is chosen from para-aramids, meta-aramids, polypropylene, polyamide, polyethylene terephthalate, polyester, linen, hemp, glass, quartz, carbon, basalt.

Embodiment 28. A use of a dry preform obtained by knitting a rectilinear weft in 3D for the manufacture of a product of composite material comprising areas with different functionalities.

Embodiment 29. The use of embodiment 28, wherein the dry preform is obtained by knitting a mixed yarn comprising polymeric material and reinforcing material.

Embodiment 30. The use of embodiment 28, wherein the dry preform is obtained by knitting a yarn of reinforcement material; of the polymeric material being added during an injection step in a mold.

Embodiment 31. The use of embodiment 28, wherein at least one area of the product comprises from 55% to 85% polymeric material by weight of the final product.

Embodiment 32. The use of embodiment 28, wherein the preform is produced by knitting a mixed yarn comprising polymeric material and reinforcing material.

Embodiment 33. The use of embodiment 28, wherein the preform is produced by knitting a reinforcing yarn; the polymeric material being introduced in a liquid way into a mold.

Embodiment 34. The use of embodiment 28, wherein the preform comprises at least two areas comprising different reinforcing materials.

Embodiment 35. The use of embodiment 28, wherein the two areas of the preform are capable of forming areas having different flexibility in the final composite product.

### EXAMPLES

The concepts described herein will be further described in the following Examples, which do not limit the scope of the invention described in the claims.

### Example 1

### Composite Product that Includes a Rigid Area and a Flexible Area

A 3D preform is knitted, in a single piece, by the straight weft knitting method.

In the areas intended to form the rigid pieces of the finished product, the yarn consists of carbon reinforcing fibers and thermoplastic fibers of low melting polyethylene terephthalate (LPET for “low melt polyethylene terephthalate”). Reinforcement fibers represent 20 to 45% of the total volume of fibers.

In another area intended to form the flexible piece of the finished product, the yarn consists of Kevlar reinforcing fibers and low-melting polyethylene terephthalate (LPET) thermoplastic fibers. Reinforcement fibers represent 15% to 37% of the total volume of fibers.

In the areas intended to form the rigid pieces, the densities are from 4 rows/cm to 6 rows/cm and 2 columns/cm to 2.8 columns/cm. The basis weight is 800 g/m² to 2000 g/m².

In the area intended to form the flexible piece of the finished product, the densities are from 3.7 rows/cm to 5.5 rows/cm and 2 columns/cm to 2.7 columns/cm. The basis weight is 400 g/m² to 1200 g/m².

The 3D preform is placed in a steel mold and counter-mold and heated to a temperature of 190° C. to 230° C. and to a pressure between 1 bar and 4 bars.

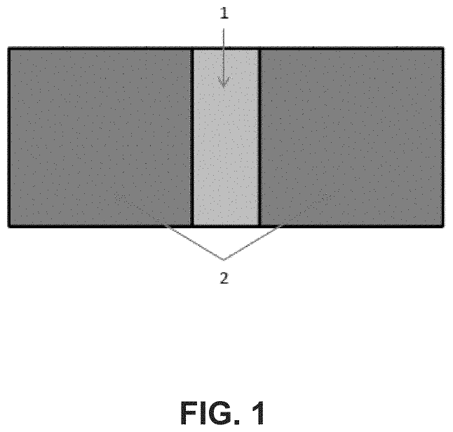

The finished product, illustrated in FIG. 1, has two rigid areas 2, the mechanical properties of which are a Young's modulus of from 10 GPa to 30 GPa and a breaking strength of 60 MPa to 600 MPa, and a flexible area 1, the mechanical properties of which are a Young's modulus of from 2 GPa to 15 GPa of and a breaking strength of 30 MPa to 450 MPa.

The flexible area of this type of product can serve as a hinge, a vibration damper, or provide a “soft” contact.

### Example 2

### Composite Product having Different Abrasion Resistance Areas

A 3D preform is knitted, in one piece, by the straight weft knitting method.

In the areas intended to form the machinable (drilling, trimming) parts of the finished product, the yarn consists of glass reinforcing fibers. The reinforcement fibers represent 20% to 45% of the total volume.

In the areas intended to form the abrasion-resistant parts of the finished product, the yarn is made of Kevlar reinforcing fibers. The reinforcement fibers represent 20% to 45% of the total volume.

In the areas intended to form the machinable parts, the densities are 3 rows/cm to 6 rows/cm and 2 columns/cm to 2.7 columns/cm. The basis weight is 1200 g/m² to 2500 g/m².

In the areas intended to form the abrasion resistant parts of the finished product, the densities are 3 rows/cm to 6 rows/cm and 2 columns/cm to 2.8 columns/cm. The basis weight is 800 g/m² to 2000 g/m².

The 3D preform is placed in a steel mold with flexible “bladder” counter-mold. An epoxy polymer is injected and the whole is heated to a temperature of 130° C. to 190° C. and to a pressure of between 1 bar and 4 bars.

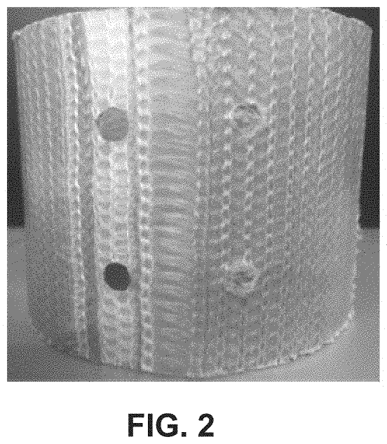

The finished product, illustrated in FIG. 2, has abrasion-resistant areas the mechanical properties of which are a Young's modulus of from 4 GPa to 19 GPa and a breaking strength of 100 MPa to 1000 MPa, and machinable areas the mechanical properties of which are a Young's modulus of from 3 GPa to 15 GPa and a breaking strength of 70 MPa to 850 MPa.

In FIG. 2, it can be seen that holes have been drilled in the machinable area (on the left) whereas in the abrasion-resistant area, the drilling attempt does not enable the formation of clear holes.

### Example 3

### Composite Product that Includes Thermally Conductive Areas and Thermally Insulating Areas

A 3D preform is knitted, in one piece, by the straight weft knitting method.

In the areas intended to form the conductive parts of the finished product, the yarn consists of carbon reinforcing fibers. The reinforcement fibers represent 33% to 45% of the total volume.

In the areas intended to form the insulating parts of the finished product, the yarn is made up of Kevlar reinforcing fibers. The reinforcement fibers represent 33% to 45% of the total volume.

In the areas intended to form the conductive parts, the densities are 3 rows/cm to 6 rows/cm and 2 columns/cm to 2.8 columns/cm. The basis weight is 800 g/m² to 2000 g/m².

In the areas intended to form the insulating parts of the finished product, the densities are 3 rows/cm to 6 rows/cm and 2 columns/cm to 2.7 columns/cm. The basis weight is 500 g/m² to 1500 g/m².

The 3D preform is placed in a steel mold with steel counter mold. An epoxy polymer is injected and the whole is heated to a temperature of 130° C. to 190° C. and to a pressure of between 1 bar and 4 bars.

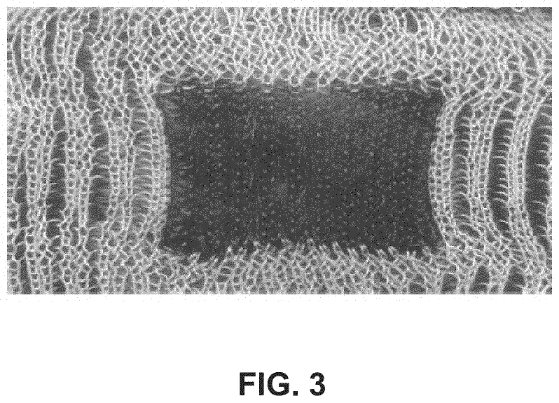

The finished product, shown in FIG. 3, includes a conductive area in the center, the thermal conductivity of which is 2.5 Wm/K to 8 Wm/K and an insulating area around the periphery, the thermal conductivity of which is 0.2 Wm/K to 1 Wm/K.

The two areas can also be distinguished by their electrical conductivity.

The invention is not limited to these examples and other functionalities can also be achieved without exceeding the scope of the present invention. One can, for example, also design areas that are soft to the touch and rough areas, etc.

### Example 4

### Product with Different Transparency Areas

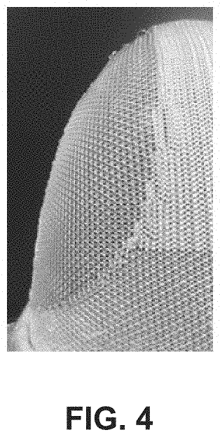

FIG. 4 illustrates a 3D preform knitted, in one piece, by the straight weft knitting method.

The preform has an area that includes only polycarbonate fibers.

The densities are 4 rows/cm to 6 rows/cm and 2 columns/cm to 2.8 columns/cm. The basis weight of this area is 500 g/m² to 1300 g/m².

The same preform includes another composite area composed of 20% to 45% by volume of glass fibers and 80% to 55% of polycarbonate. The densities are 3.6 rows/cm to 5 rows/cm and 2 columns/cm to 2.7 columns/cm. The basis weight of this area is 550 g/m² to 1800 g/m².

The two areas form a single knitted piece without sewing or assembly.

The 3D preform is placed in a steel mold with counter-mold. The whole is heated to a temperature of 200° C. to 250° C. and to a pressure between 3 bars and 10 bars.

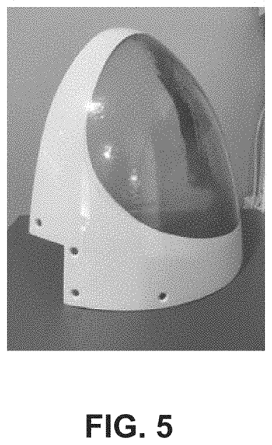

The finished product is shown in FIG. 5. The use of the suitable polymer makes it possible to make the pure polymer area transparent after transformation.

The mechanical properties are, in the pure polymer area, a Young's modulus of from 1 GPa to 4 GPa of and a breaking strength of 40 MPa to 70 MPa; and in the composite area, a Young's modulus of 4 GPa to 19 GPa and a breaking strength of 50 MPa to 600 MPa.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method for manufacturing a product made of composite material, wherein the product comprising a matrix of a polymeric material reinforced with fibers, the polymeric material having a melting point lower than the melting point of a material constituting the reinforcing fibers, wherein the product further comprises at least two areas with different functionalities, wherein at least one area comprises at least 50% polymeric material by weight of the final product, wherein the process comprise the following steps:
making a knit in three dimensions and in a continuous piece by weft knitting, the knit constituting a dry preform corresponding to the shape of the product to be obtained, wherein the dry preform comprises at least two areas having different compositions,
shaping by heating under pressure to reach at least the melting point temperature of the polymeric material without reaching the temperature of the melting point of the reinforcing material, and
cooling of the product thus obtained.

2. The method according to claim 1, wherein production of the knitting in three dimensions is carried out by knitting a straight weft.

3. The method according to claim 1, wherein at least one area of the final product comprises from 55% to 85% polymeric material by weight of the final product.

4. The method according to claim 1, wherein the preform is produced by knitting a mixed yarn comprising polymeric material and reinforcing material.

5. The method according to claim 1, wherein the preform is produced by knitting a reinforcing yarn; the polymeric material being introduced in a liquid way into a mold.

6. The method according to claim 1, wherein the preform comprises at least two areas comprising different reinforcing materials.

7. The method according to claim 1, wherein the two areas of the preform are capable of forming areas having different flexibility in the final composite product.

8. The method according to claim 1, wherein the two areas of the preform are capable of forming areas having different thermal conductivity in the final composite product.

9. The method according to claim 1, wherein the two areas of the preform are capable of forming areas having different abrasion resistance in the final composite product.

10. The method according to claim 1, wherein the two areas of the preform are capable of forming areas having different transparency.

11. The method according to claim 1, wherein the polymeric material is chosen from polycarbonate, polypropylene, polyamide, polyurethane, PMMA, low-density polyethylene terephthalate, polyether imide, polyetheretherketone (PEEK), polyetherketoneketone (PEKK).

12. The method according to claim 1, wherein the reinforcing material is chosen from para-aramids, meta-aramids, polypropylene, polyamide, polyethylene terephthalate, polyester, linen, hemp, glass, quartz, carbon, basalt.

13. A use of a dry preform obtained by knitting a rectilinear weft in 3D for the manufacture of a product of composite material comprising areas with different functionalities.

14. The use of claim 13, wherein the dry preform is obtained by knitting a mixed yarn comprising polymeric material and reinforcing material.

15. The use of claim 13, wherein the dry preform is obtained by knitting a yarn of reinforcement material; of the polymeric material being added during an injection step in a mold.

16. The use of claim 13, wherein at least one area of the product comprises from 55% to 85% polymeric material by weight of the final product.

17. The use of claim 13, wherein the preform is produced by knitting a mixed yarn comprising polymeric material and reinforcing material.

18. The use of claim 13, wherein the preform is produced by knitting a reinforcing yarn; the polymeric material being introduced in a liquid way into a mold.

19. The use of claim 13, wherein the preform comprises at least two areas comprising different reinforcing materials.

20. The use of claim 13, wherein the two areas of the preform are capable of forming areas having different flexibility in the final composite product.
